(19) United States
(12) Patent Application Publication
(10) Pub. No.: US 2023/0242268 A1
(43) Pub. Date: Aug. 3, 2023

(54) FILTERING DEVICE FOR LIQUIDS, IN PARTICULAR FOR FUELS

(71) Applicants: Maria CUTORE, Aci Castello (IT); Marzia CUTORE, Monte Compatri (IT); Emanuele CUTORE, Rome (IT)

(72) Inventors: Marzia CUTORE, Monte Compatri (IT); Emanuele CUTORE, Monte Compatri (IT); Gaetano CUTORE, Monte Compatri (IT)

(21) Appl. No.: 18/024,307

(22) PCT Filed: Sep. 10, 2020
(86) PCT No.: PCT/IT2020/000064

§ 371 Date: Mar. 2, 2023

(51) Int. Cl. B64D 37/34; F02M 37/34

(52) U.S. Cl. CPC B64D 37/34; F02M 37/34

(57) ABSTRACT

The present invention relates to a filtering device for liquids and in particular for filtering fuels for aeronautical use (avio).

The present invention relates to a filtering device for liquids and in particular for filtering fuels for aeronautical use (avio). In particular, the invention relates to a cartridge for such device.

Currently the filters used for filtering liquids and, in particular, avio fuel, usually are structurally based upon pleated longitudinal filtering sheets supported, or not supported, by—both vertical and horizontal—metallic and/or plastic structures capable of contrasting the pressure acting on the filtering elements which, once the solid contaminants have deposited and infiltrated, can increase until breaking through the sheets themselves. The coalescent filters (subjected to greater pressure), sold by the most famous constructors on the market, are of this type.

The now described filters have a series of drawbacks, the consequences thereof obviously result to be the more serious the more central is the need and impossibility of recontroling and/or locking the effluent. In particular, the need appears clear to be able to provide avio fuel filtered correctly—that is within the limit values established by authorities—for the avio-suppliers in flight line, soon upstream of the tanks for the aircrafts.

The first and most serious drawback results to be the structural impossibility to sustain high operating and/or peak pressures. The breakthrough risk, in fact, is accompanied by the risk of use in apparatuses where (even instantaneous) breakthrough can go unnoticed due to checks based upon the reading of differential manometers arranged on the filter containment vessel.

Moreover, the creation of stiffeners supporting the structures, mainly for those of the pleaded filtering filters, usually is obtained by thermal melting of plastic portions and/or gluing, at least of the ends and by melting, gluing and/or arrangement of transversal plastic reinforcements for the filtering elements of lenticular type. Such processes not only constrain a priori the longitudinal sizes of the filter—in the pleaded septum filters—by making them not modular, but they lower gradually the level of eco-compatibility and reuse thereof. Therefore, the reuse level of the components results to be reduced, however without obtaining a real increase in the level of resistance to breakthrough. This involves the disposal of the whole filter with burdens for the environment. Similarly, the lenticular filters constrain the filtering disks with usually plastic and thermo-welded, and thus not reusable, supports.

An object of the present invention is to obviate the breakthrough risk and to allow a widely modular and elastic construction, so as to allow to make available the maximum filtering surface per volume unit and the most complete reuse of the construction components.

The principle underlying the invention is the exploitation of the flow directionality in order to create sealed and adjacent “filtering chambers”, with balancing of pressures on the filtering septa.

The above-illustrated objects are achieved through a filtering cartridge as defined in claim 1.

Additional object of the present invention is a filtering device for liquids, in particular for filtering fuels for aeronautical use, as defined in claim 18.

Additional features of the invention are reported in the corresponding depending claims.

The features and the advantages of the present invention will result more evident from the description of preferred, but not exclusive, embodiments thereof, illustrated by way of example, but not for limitative purposes, in the enclosed drawing tables wherein:

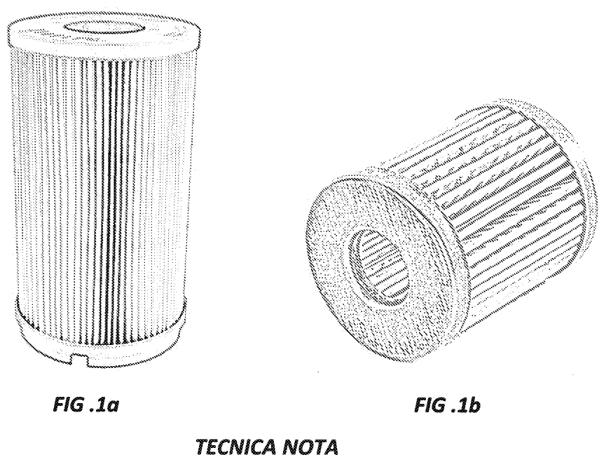

FIGS. 1a and 1b show cartridge examples according to the most widespread known art;

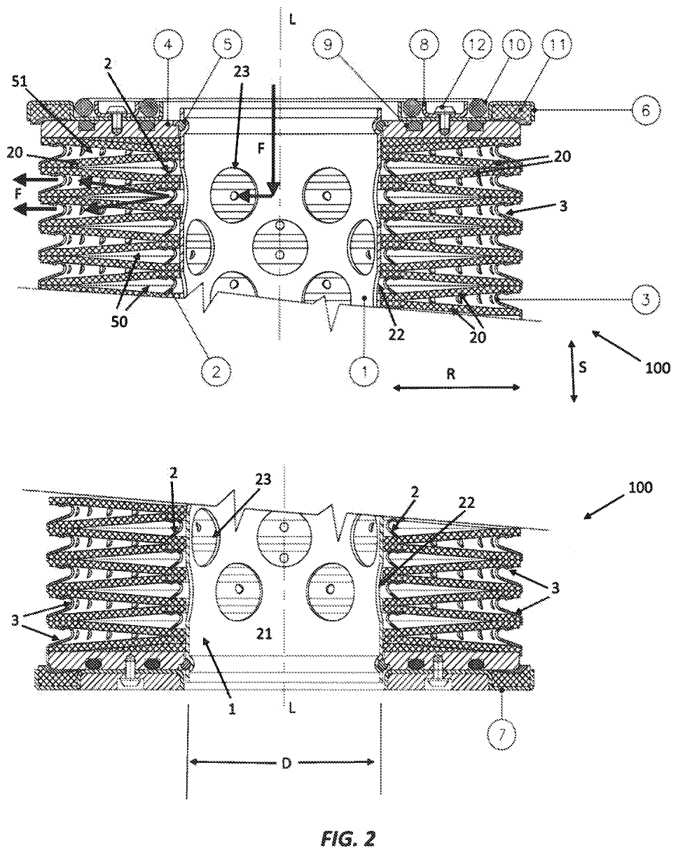

FIG. 2 is a cutaway section view of a cartridge according to a first embodiment of the invention;

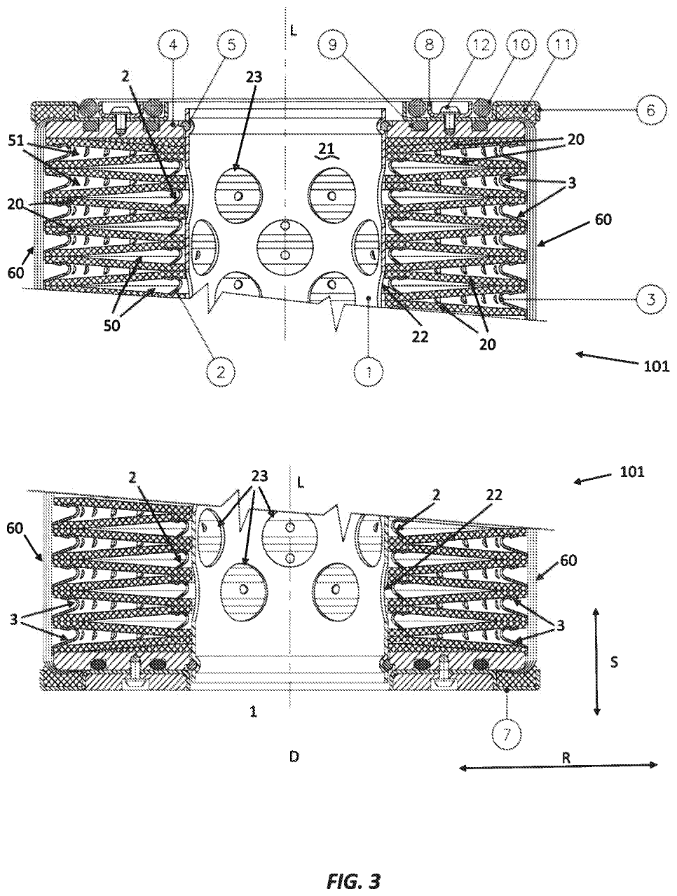

FIG. 3 is a cutaway section view of a cartridge according to a second embodiment of the invention;

FIG. 4 is a perspective view of a first filtering element according to the invention;

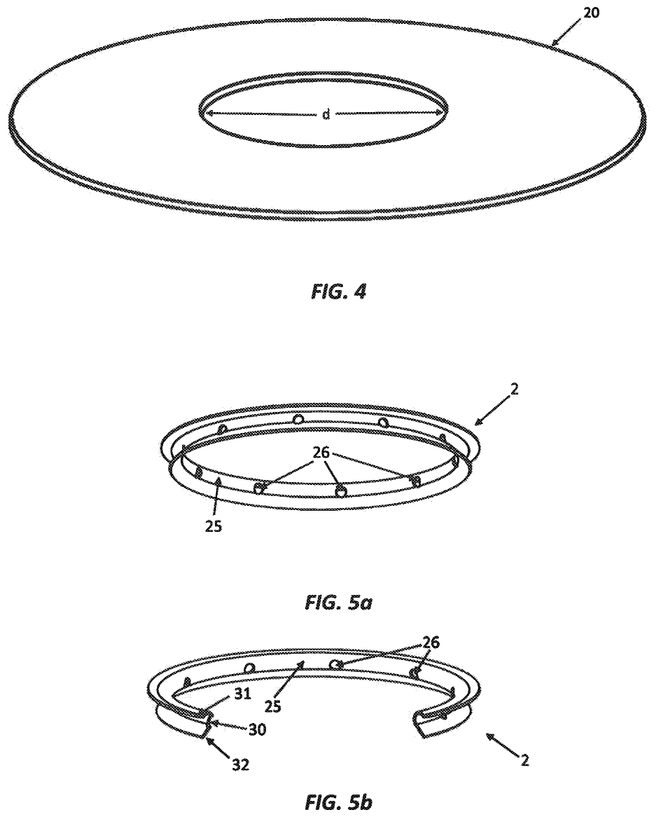

FIGS. 5a and 5b are views of a first spacer element according to the invention;

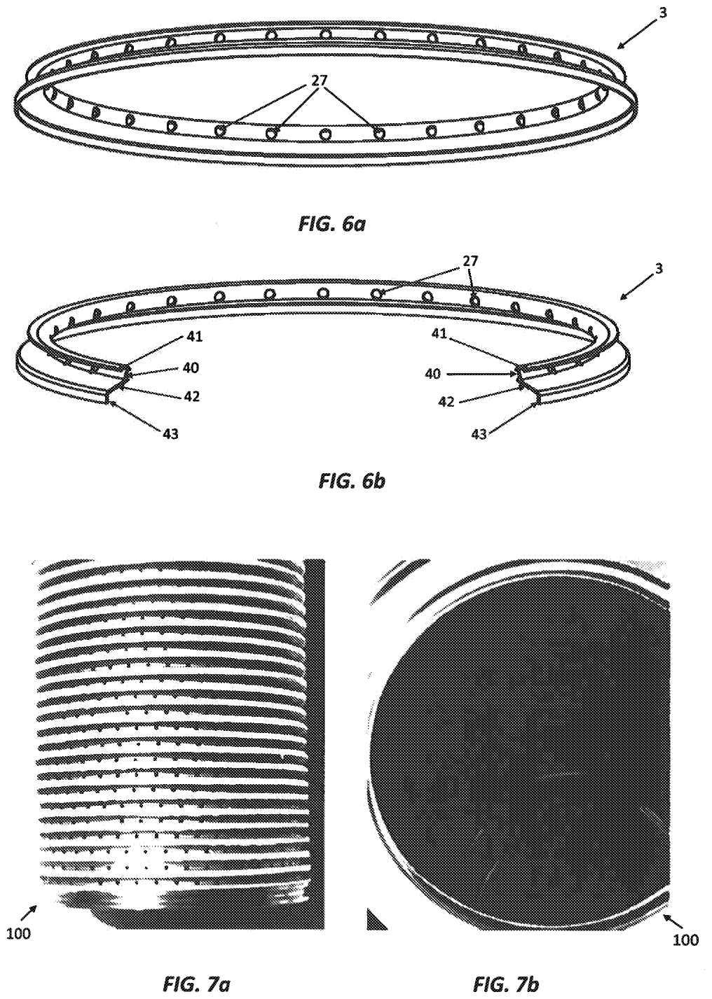

FIGS. 6a and 6b are views of a second spacer element according to the invention; and

FIGS. 7a and 7b are views of a cartridge according to the invention, from outside and from inside, respectively.

By firstly referring to FIG. 2, the set of a cartridge according to the invention is designated with 100.

The filtering cartridge 100 first of all comprises a central duct 1. The central duct 1 can be considered as the point for inletting the fluid to be filtered, as designated with arrow F1 in FIG. 2. However, it is to be meant that the fluid flowing direction inside the filter can even be opposite to the one herein reported by pure way of example.

The central duct 1 has a longitudinal axis L, an internal wall 21 and an external wall 22. Preferably, but not necessarily, the central duct 1 has substantially cylindrical shape, still more preferably with circular section. The section of the duct 1 has an extension which will depend upon the flow rate requested to the filter, preferably comprised between 20 and 67 cm².

According to the invention, the duct 1 further has a plurality of through-holes 23 between said external wall 21 and said internal wall 22.

Such through-holes, according to some embodiments of the invention, have a perforated surface comprised between 490 and 707 mm².

Such through-holes 23 can be comprised, in number, between 45 and 108.

A plurality of first filtering elements 20, superimposed on each other according to a direction S parallel to the axis L, are placed around the central duct 1.

Such first filtering elements 20 preferably are made of cellulose and/or the like and, still preferably (but not necessarily) in form of flat circular crowns, with an internal diameter d substantially equal to the external diameter D of the central duct 1.

A plurality of first spacers 2 are then placed still around the central duct 1, concentrically around the central duct 1, close to its external wall 22.

Each one of the first spacers 2 have a wall 25 provided with first holes 26 directed according to a radial direction R with respect to the axis L.

Similarly, a plurality of second spacers 3 are arranged concentrically around the central duct 1, but in remote position with respect to its external wall 22. Even each one of the second spacers 3 has a wall provided with second holes 27 directed according to the radial direction R with respect to the axis L.

Said first filtering elements 20, along the direction S, are alternatively interspaced with one of said first spacers 2 and one of said second spacers 3.

In this way, the first spacer elements 2 result to be interspaced, along the direction S, with pairs of first filtering elements 20 in contact with each other in proximity to the first spacers 2. Similarly, the second spacers 3 are interspaced, along the direction S, with pairs of said first filtering elements 20 in contact with each other in proximity to the second spacers 3.

Globally, the first and second spacers 2, 3, together with portions of the filtering elements 20, form chambers 50, 51 for inletting or outletting the fluid to be filtered, through said first and holes 26, 27.

The shape of the first and second spacers, in particular the section shape of their profile, makes possible an elastic stacking of the same and an effect of obliged centering, so as to ease the production and disassembling thereof and to minimize the environmental impact, by extending the possibilities of reusing the cartridge.

As shown by way of example in the figures, the first spacers 2 can be advantageously implemented in form of rings, with a section profile having a bent central portion 30 and substantially rectilinear extremal portions 31, 32, wherein the bent portion 30 has the first holes 26.

Similarly, the second spacers 3 can be advantageously implemented in form of rings, with a section profile having a bent central portion 40 and substantially rectilinear extremal portions 41, 42, one of said extremal portions 41 having a developing terminal region 43 so that, during use, it is arranged parallel to the axis L, wherein the bent portion 40 has the second holes 27.

According to embodiments of the invention, each one of the first spacers 2 comprises between 17 and 30 first holes 26, preferably distributed along the whole bent central portion 30. The first holes 26 have a perforated surface comprised between 2 and 4 mm².

Similarly, according to some embodiments, each one of the second spacers 3 comprises between 30 and 45 second holes 27, preferably distributed along the whole bent central portion 40. The second holes 27 have a perforated surface comprised between 2 and 4 mm².

The cartridge, according to some embodiments of the present invention, comprises clamping means 4, 5, 6, 7, 8, 9, 10, 11, 12, apt to exert a pressure on the set of said first and second spacers 2, 3 and said first filtering elements 20, in contrast with the elastic force exerted by said first and second spacers 2, 3.

The clamping means 4, 5, 6, 7, 8, 9, 10, 11, 12, by way of example, comprises closing ring nuts 4, 6, 7, gaskets 5, 9, 10, 11 and fastening screws 8, 12, so as to implement a sealing tightening against the external wall 22 of the central duct.

At last, according to some embodiments of the invention, for example the one shown in FIG. 3, the cartridge 101 can include at least a second filtering element 60, arranged externally to the cartridge itself. For example, external filtering layers can be provided with the purpose of implementing the coalescence effect.

The structure of the cartridge 101, then, as a whole is so that independently from the presence of second filtering elements 60, and independently from the direction of the fluid flow, the fluid, through the holes of the metal rings, enters the inlet chambers still formed by two of said first filtering elements 20 and one between said first or second spacers 2, 3. The fluid then passes through the first filtering elements to reach the adjacent outletting chambers still formed by two of said first filtering elements 20 and one between said first or second spacers 2, 3.

This, together with the elastic clamping, makes that the dirt remains trapped in the septa and that, once it has accumulated on and in the same, it produces the same push on the adjacent chambers.

In this way, even in case of consistent clogging, the possible pressure and/or deformation of one of the first filtering elements 20 is automatically contrasted by the one which has created in the adjacent chamber, not allowing the breakthrough of the filtering element. The accumulation of contaminants has the single effect of reducing the possibility of outflow, that is the flow rate through the filtering elements 20. The clogging can obviously be detected by the variation in pressure astride the filter and thus it guarantees the effluent quality.

As already indicated, preferably each one of said first and second spacers 2, 3, as well as the central duct 1 are made of metal, preferably stainless steel.

The present invention has been so far described with reference to preferred embodiments thereof. It is to be meant that each one of the technical solutions implemented in the preferred embodiments, herein described by way of example, could advantageously be combined differently therebetween, in order to create other embodiments belonging to the same inventive core and however within the protective scope of the herebelow reported claims.

What is claimed is:

1. A cartridge for a filtering device for liquids, in particular for filtering fuels for aeronautical use, comprising:
a central duct having a longitudinal axis (L), an internal wall and an external wall, said duct further having a plurality of through-holes between said external wall and said internal wall;
a plurality of first filtering elements arranged around such central duct, superimposed on each other according to a direction (S) parallel to the axis (L);
a plurality of first spacers, apt to be arranged concentrically around said central duct close to its external wall, each one of said first spacers having a wall provided with the first holes according to a radial direction (R) with respect to the axis (L);
a plurality of second spacers, apt to be arranged concentrically around said central duct in remote position with respect to its external wall, each one of said second spacers having a wall provided with second holes according to a radial direction (R) with respect to the axis (L);
wherein, along the direction (S), said first filtering elements result to be alternatively interspaced with one of said first spacers and one of said second spacers, so that said first and second spacers result to be interspaced with pairs of said first filtering elements in contact with each other in proximity to said first spacers and said second spacers, respectively,
the arrangement being so that said first and second spacers, with portions of said filtering elements, form chambers for inletting and outletting the fluid to be filtered, through said first and second holes.

2. The cartridge according to claim 1, wherein said central duct has substantially cylindrical shape.

3. The cartridge according to claim 1, wherein said first filtering elements are implemented in form of flat circular crowns, with an internal diameter (d) substantially equal to the external diameter (D) of said central duct.

4. The cartridge according to claim 1, wherein said first filtering elements are made of cellulose and/or the like.

5. The cartridge according to claim 1, wherein said first spacers are implemented in form of rings, with a section profile having a bent central portion and substantially rectilinear extremal portions, said bent portion having said first holes.

6. The cartridge according to claim 1, wherein said second spacers are implemented in form of rings, with a section profile having a bent central portion and substantially rectilinear extremal portions, one of said extremal portions having a developing terminal region so that, during use, it is arranged parallelly to the axis (L), said bent portion having said second holes.

7. The cartridge according to claim 1, wherein said first holes have a perforated surface comprised between 2 and 4 mm².

8. The cartridge according to claim 1, wherein said second holes have a perforated surface comprised between 2 and 4 mm².

9. The cartridge according to claim 1, wherein said through-holes have a perforated surface comprised between 490 and 707 mm².

10. The cartridge according to claim 1, wherein each one of said first spacers comprises between 17 and 30 of said first holes.

11. The cartridge according to claim 1, wherein each one of said second spacers comprises between 30 and 45 of said second holes.

12. The cartridge according to claim 1, wherein said central duct comprises between 45 and 108 of said through-holes.

13. The cartridge according to claim 1, wherein each one of said first and second spacers are made of metal, preferably stainless steel.

14. The cartridge according to claim 1, wherein said central duct is made of metal, preferably stainless steel.

15. The cartridge according to claim 1, further comprising clamping means apt to exert a pressure on the set of said first and second spacers and said first filtering elements, in contrast with the elastic force exerted by said first and second spacers.

16. The cartridge according to claim 15, wherein said clamping means implements a sealing against the external wall of said central duct.

17. The cartridge according to claim 1, further comprising at least a second filtering element, arranged externally to the cartridge itself.

18. A filtering device for liquids, in particular for filtering fuels for aeronautical use, comprising a cartridge according to claim 1.
